(19) United States
(12) Patent Application Publication
(10) Pub. No.: US 2006/0084007 A1
(43) Pub. Date: Apr. 20, 2006

(54) Method for curing aminoplasts

(76) Inventors: Manfred Ratzsch, Wilhering/Thalheim (AT); Hartmut Bucka, Eggendorf (AT); Martin Burger, Linz (AT); Uwe Muller, Luftenberg (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/517,963

(22) PCT Filed: Jun. 12, 2003
(86) PCT No.: PCT/EP03/06176

§ 371 Date: Aug. 9, 2005

(30) Foreign Application Priority Data
Jun. 14, 2002 (AT) A 903/ 2002

(51) Int. Cl. G03C 1/76; D02G 3/00; F16J 15/20

(52) U.S. Cl. 430/270.1; 428/364; 428/365

(57) ABSTRACT

A method for curing aminoplasts, during which layers having layer thicknesses of up to 300 um or filaments and fiber fibrids having a diameter of up to 300 um, which consist of: i) 95 to 99.95% by mass of solvent-free meltable aminoplast polycondensates with molar masses ranging from 1000 to 300000; j) 5 to 0.05% by mass of curing agents, which can be activated by actinic light and which are comprised of acidifiers of the blocked sulfonic acid and/or halogen-substituted triazine derivative and/or onium salt type, and optionally; k) 1 to 20% by mass, with regard to the meltable aminoplast polycondensates, of unmodified and/or modified maleic anhydride copolymers, and/or; i) 0.1 to 5% by mass, with regard to the meltable aminoplast polycondensates, of nanoparticles. The aminoplasts are cured by irradiating them with actinic light at a temperature between the melting point of the aminoplast polycondensate and the thermoinduced decomposition temperature of the light-activatable curing agents. This method enables the production of, preferably, textile fabrics or coatings.

The invention relates to a process for curing amino resins and also to amino resin products produced by the process.

Amino resins such as melamine-formaldehyde resins or melamine-urea-formaldehyde resins [Ullmann's Encyclopaedia of Industrial Chemistry (1987), vol. A2, 130-131] are known. A disadvantage associated with the production of products from melamine resins is the difficulty of processing them by customary thermoplastic processing methods such as extrusion, injection molding or blow molding. Low molecular mass melamine resin precondensates have a melt viscosity which is too low for these processing methods, and can be processed only in the form of highly filled molding compounds with long cycle times and with curing of the products (Woebcken, W., Kunststoff-Handbuch vol. 10, “Duroplaste” [Thermosets], Carl Hanser Verlag Munich 1988, pp. 266-274).

Fibres [DE 195 15 277 A1, EP 0 093 965 A2], foams or coatings [DE 24 22 803 B1] of melamine resins can be produced only starting from solutions of the melamine resin precondensates, with curing during the shaping operation, owing to the low melt viscosity of the melamine resin precondensates.

Known curing agents in the production of melamine resin fibres are organic acids such as formic acid, acetic acid, amidosulphonic acids or amino acids [DE 195 15 277 A1] or alkali metal salts such as alkali metal disulphides, alkali metal phosphates or alkali metal polyphosphates [EP 0 093 965 A2].

Also known is the use of iodonium salts (DE 100 63 066) or of blocked sulphonic acids (WO 00 10972) as a component of radiation-sensitive polymerizable or crosslinkable formulations.

An object of the present invention is a process for curing amino resins with which solvent-free thin amino resin layers or amino resin filaments can be cured.

The object has been achieved by a process for curing amino resins in which, in accordance with the invention, layers with thicknesses up to 300 μm or filaments or fibrids with a diameter up to 300 μm and composed of
a) from 95 to 99.95% by mass of solvent-free meltable amino resin polycondensates having molar masses of 300 to 300 000,
b) from 5 to 0.05% by mass of curing agents which can be activated by actinic light and are composed of
b1) acid formers of the type of blocked sulphonic acid of the general formula (I)
   R₁—SO₂—O—R₂ (I)
R₁=unsubstituted or substituted aryl, biphenyl or alkyl,
R₂=4-nitrobenzyl, pentafluorobenzyl 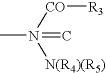
   substituents, or 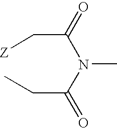
   substituents,
Z=_{C6-C24}-aryl, _{C2-C4}-alkyl, _{C2-C4}-alkenyl, _{C7-C8}-bicycloalkenyl,
where R₃=non-substituted or substituted alkyl or aryl,
R₄═H, C₁-C₁₂-alkyl, phenyl, C₂-C₉-alkanoyl or benzyl,
R₅═H, C₁-C₁₂-alkyl or cyclohexyl or R₃ and R₄ or R₅ together with the atoms to which they attached form a 5- to 8-membered ring which can be fused by 1 or 2 benzo radicals, and/or
b2) halogen-substituted triazine derivatives of the general formula (II) 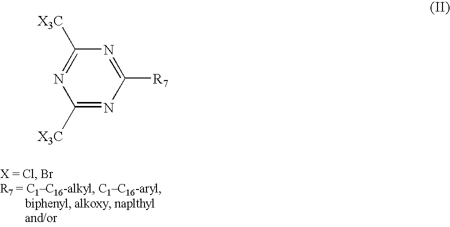
b3) onium salts of the type of aryldiazonium salts, diarylhalonium salts, triarylsulphonium salts, triarylselenonium salts and/or N-alkoxypyridinium salts,
   and if desired
c) from 1 to 20% by mass, based on the meltable amino resin polycondensates, of non-modified and/or modified maleic anhydride copolymers, and/or
d) from 0.1 to 5% by mass, based on the meltable amino resin polycondensates, of nanoparticles in the form of phyllosilicates, hydrophilic or hydrophobic synthetic silicas, calcium carbonate or metal oxides of the ZnO, SnO, Al₂O₃ or TiO₂ type.
   are cured by irradiation with actinic light at a temperature between the melting point of the amino resin polycondensate and the thermoinduced decomposition temperature of the light-activable curing agents, and if desired are subjected to a thermal aftercure below 250° C.

Suitable light sources are point light sources and panel-form emitters. Examples of suitable light sources are carbon arc lamps, xenon arc lamps, mercury emitters in the low pressure, medium pressure and high pressure range, which may where appropriate have been doped with metal halides, such as metal-halogen lamps, microwave-excited metal vapour lamps, excimer lamps, superactinic fluorescent tubes, fluorescent lamps, argon incandescent lamps, flash lamps, and laser light sources such as excimer lasers.

In the process for curing amino resins preferred acid formers of the type of blocked sulphonic acid of the general formula
R₁—SO₂—O—R₂ (I)
are blocked sulphonic acids in which the substituents
R₁=unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl or C₇-C₁₂-arylalkyl,
R₂=4-nitrobenzyl, pentafluorobenzyl, 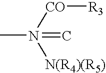
   substituents, or 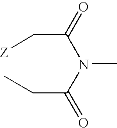
   substituents,
Z=_{C6-C24}-aryl, _{C2-C4}-alkyl, _{C2-C4}-alkenyl, _{C7-C8}-bicycloalkenyl,
where
R₃═C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl and/or C₇-C₁₂-arylalkyl, C₁-C₈-alkoxy, C₅-C₈-cycloalkoxy, phenoxy or H₂N—CO—NH—, —CN, C₂-C₅-alkyloyl, benzoyl, C₂-C₅-alkoxycarbonyl, phenoxycarbonyl, morpholino, piperidino, C₁-C₁₂-alkyl, C₁-C₄-haloalkyl, C₂-C₆-alkenyl, C₅-C₁₂-cycloalkyl, unsubstituted or singly or multiply halogen-, —C₁-C₄-haloalkyl-, C₁-C₁₆-alkyl, C₁-C₄-alkoxy, C₁-C₄-alkyl-CO—NH—, phenyl-CO—NH—, benzoyl- and/or nitro-substituted C₆-C₁₀-aryl, C₇-C₁₂-arylalkyl, C₁-C₈-alkoxy, C₅-C₈-cycloalkoxy-, phenoxy- or H₂N—CO—NH—,
R₄═H, C₁-C₁₂-alkyl, phenyl, C₂-C₉-alkanoyl or benzyl
R₅═H, C₁-C₁₂-alkyl or cyclohexyl,
or R₃ and R₄ or R₅ together with the atoms to which they are attached form a 5- to 8-membered ring which can be fused by 1 or 2 benzo radicals.

Examples of preferred blocked sulphonic acids are benzil monoxime tosylate, benzil monoxime p-dodecylbenzenesulphonate, 4-nitro-acetophenone oxime tosylate, ethyl α-tosyloximinocaproate, ethyl α-cyclohexylsulphonyloxyiminophenylacetate, phenyl α-(4-chlorophenyl-sulphonyloxyimino)caproate, 4,4-dimethylbenzil monoxime tosylate, dibenzyl ketone oxime tosylate, acetone oxime p-benzoylbenzene-sulphonate, α-tretralone oxime tosylate, anthraquinone monoxime tosylate, thioxanthone oxime tosylate, α-(p-toluenesuiphonyl-oxyimino)benzyl cyanide, α-(4-nitrobenzenesulphonyloxyimino)benzyl cyanide, α-(benzenesulphonyloxyimino)-4-chlorobenzyl cyanide, α-(benzenesulphoxyimino)-2,6-dichlorobenzyl cyanide, α-(2-chloro-benzenesulphonyloxyimino)-4-methoxybenzyl cyanide, 4-chloro-α-trifluoroacetophenone oxime benzenesulphonate, fluorene oxime tosylate, α-(benzenesulphonyloxyimino)ureidocarbonylacetonitrile, α-(p-toluenesulphonyloxyimino)benzoylacetonitrile, 2,3-dihydro-1,4-naphthoquinone monoxime tosylate, acetophenone oxime tosylate, chroman oxime tosylate, 2-nitrobenzyl sulphonate, 2,6-dinitrobenzyl benzenesulphonate, 4-nitrobenzyl 9,10-dimethoxyanthracene-2-sulphonate, 2-methylsulphonyloxyimino-4-phenylbut-3-enenitrile, 4-cyclo-hex-1 -enyl-2-methylsulphonyloxyiminobut-3-enenitrile, 4-furan-2-yliso-propylsulphonyloxyiminobut-3-enenitrile and 2-pentafluorophenyl-sulphonyloxyimino-4-phenylbut-3-enenitrile.

One example of preferred blocked sulphonic acids in which R₂ is an 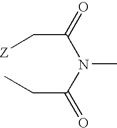
substituent,
Z=_{C6-C24}-aryl, _{C2-C4}-alkyl, _{C2-C4}-alkenyl, _{C7-C8}-bicycloalkenyl, is the blocked sulphonic acid of the structure

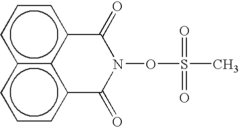

Particular preference is given in the process of the invention for curing amino resins to acid formers of the type of blocked sulphonic acid of the general formula
R₁—SO₂—O—R₂ (I)

in which the blocked sulphonic acids are acid formers of the formula

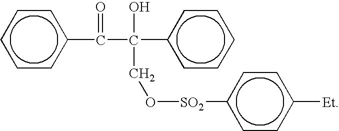

Examples of halogen-substituted triazine derivatives which can be used in the process of the invention as curing agents which can be activated by actinic light are 1,3,5-tribromomethyl-2,4,6-triazine and 1,3,5-trichloro-methyl-2,4,6-triazine.

In the process of the invention for curing amino resins preferred halogen-substituted triazine derivatives of the general formula (II)

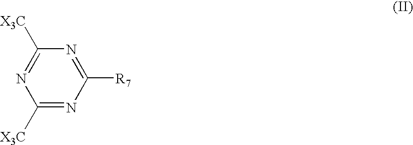

are triazine derivatives in which
X═Cl and R₇=p=methoxyphenyl.

Examples of onium salts which can be used in the process of the invention as curing agents which can be activated by actinic light are
aryldiazonium salts such as phenyldiazonium hexafluoroarsenate, tolyidiazonium tetrafluoroborate and phenyldiazonium hexafluorophosphate,
diarylhalonium salts such as 4-isobutylphenyl-4′-methylphenyliodonium hexafluorophosphate, 4-isobutylphenyl-4′-methylphenyliodonium 4-chlorophenyisulphonate, 4-(-menthylbut-2-yl)phenyl-4′-methylphenyl-iodonium nonafluorobutylsulphonate, diphenylbromonium hexafluoro-antimonate, diphenyliodonium 8-anilinonaphthaline-1-sulphonate, diphenyliodonium 9,10-dimethoxyanthracene-2-sulphonate and diphenylchloronium hexafluoroantimonate,
triarylsulphonium salts such as tris(4-methoxyphenyl)sulphonium hexafluoroarsenate, 3,5-dimethyl-4-hydroxyphenylsulphonium hexafluorophosphate and benzyl(p-hydroxyphenyl)methylsulphonium hexafluoroantimonate,
triarylselenonium salts such as 3,5-diphenyl-4-hydroxyphenylsulfonium tetrafluoroborate and tris(4-ethoxyphenyl)sulfonium hexafluorophosphate,
N-alkoxypyridinium salts such as N-ethoxypyridinium tetrafluoroborate or N-methoxypyridinium hexafluorophosphate.

A preferred onium salt curing agent is the onium salt of the formula

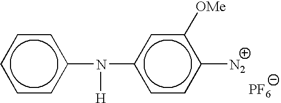

The amino resin polycondensates with molar masses of 1000 to 300 000 that are used in the process of the invention to cure amino resins are preferably polycondensates of melamine resins, urea resins, cyanamide resins, dicyandiamide resins, sulphonamide resins and/or guanamine resins.

Preferred melamine resins are polycondensates of melamine and/or melamine derivatives and C₁-C₈ aldehydes having a melamine or melamine derivative/C₁-C₈ aldehyde molar ratio of 1:1.5 to 1:6 and also their partial etherification products, it being possible for the melamine derivatives to be melamines substituted by hydroxy-C₁-C₁₀-alkyl groups, hydroxy-C₁-C₄-alkyl(oxa-C₂-C₄-alkyl)₁₋₅ groups and/or by amino-C₁-C₁₂-alkyl groups, ammeline, ammelide, melem, melon, melam, benzoguanamine, acetoguanamine, tetramethoxymethylbenzoguanamine, caprinoguanamine and/or butyroguanamine, and the C₁-C₈ aldehydes are, in particular, formaldehyde, acetaldehyde, trimethylolacetaldehyde, acrolein, furfurol, glyoxal and/or glutaraldehyde, with particular preference formaldehyde.

The melamine resins may likewise contain 0.1 to 10% by mass, based on the sum of melamine and melamine derivatives, of incorporated phenols and/or urea. Suitable phenol components include phenol, C₁-C₉-alkylphenols, hydroxyphenols and/or bisphenols.

Examples of the urea resins possibly employed in the process of the invention, besides urea-formaldehyde resins, likewise include cocondensates with phenols, acid amides or sulphonamides.

Examples of the sulphonamide resins possibly employed in the process of the invention are sulphonamide resins formed from p-toluene-sulphonamide and formaldehyde.

Examples of the guanamine resins possibly employed in the process of the invention are resins comprising as guanamine component benzoguanamine, acetoguanamine, tetramethoxymethylbenzoguanamine, caprinoguanamine and/or butyroguanamine.

Examples of the aniline resins possibly employed in the process of the invention are aniline resins which as aromatic diamines may contain, as well as aniline, toluidine and/or xylidines.

With particular advantage the process of the invention for curing amino resins uses polycondensates of melamine resins that are mixtures of meltable 4- to 1000-nucleus polytriazine ethers, where in the polytriazine ethers the triazine segments

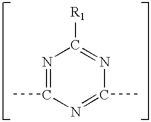

R₁═—NH₂, —NH—CHR₂—O—R₃, —NH—CHR₂—O—R₄—OH, —CH₃, —C₃H₇, —C₆H₅,
—OH, phthalimido-, succinimido-, —NH—CO-_{C5-C18}-alkyl,
—NH—C₅-C₁₈-alkylene-OH, —NH—CHR₂—O—C₅-C₁₈-alkylene-NH₂,
—NH—C₅-C₁₈-alkylene-NH₂, —NH—CHR₂—O—R₄—O—CHR₂—NH—,
—NH—CHR₂—NH—, —NH—CHR₂—O—C₅-C₁₈-alkylene-NH—,
—NH—C₅-C₁₈-alkylene-NH—, —NH—CHR₂—O—CHR₂—NH—,

R₂═H, C₁—H₇-alkyl;

R₃═C₁-C₁₈-alkyl, H;

R₄═C₂-C₁₈-alkylene,
—CH(CH₃)—CH₂—O_{-C2-C12}-alkylene-O—CH₂—CH(CH₃)—,
—CH(CH₃)—CH₂—O-_{C2-C12}-arylene-O—CH₂—CH(CH₃)—,
—[CH₂—CH₂—O—CH₂—CH₂]ₙ—, —[CH₂—CH(CH₃)—O—CH₂—CH(CH₃)]ₙ—,
—[—O—CH₂—CH₂—CH₂—CH₂—]ₙ—,
—[(CH₂)₂₋₈—O—CO-_{C6-C14}-arylene-CO—O—(CH₂)₂₋₈—]ₙ—,
—[(CH₂)₂₋₈—O—CO-_{C2-C12}-alkylene-CO—O—(CH₂)₂₋₈—]ₙ—,
   where n=1 to 200;
polyester sequences containing siloxane groups, of the type
   —[(X)₁—O—CO—(Y)₉—CO—O—(X)ᵣ]—
in which
X═{(CH₂)₂₋₈-O—CO_{-C8-C14-}arylene-CO—O—(CH₂)₂₋₈—} or
   {(CH₂)₂₋₈—O—CO_{-C2-C12-}alkylene-CO—O—(CH₂)₂₋₈—} 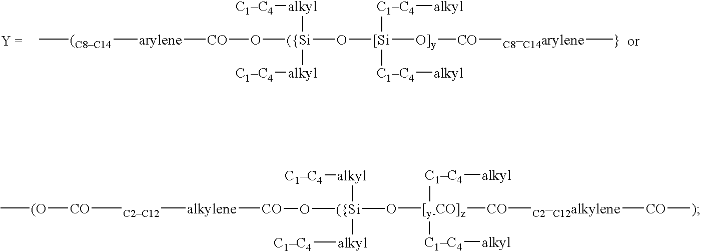
r=1 to 70; s=1 to 70 and y=3 to 50;
polyether sequences containing siloxane groups, of the type 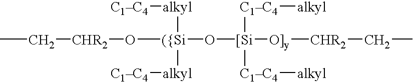
where R₂═H; C₁-C₄-alkyl and y=3 to 50;
sequences based on alkylene oxide adducts of melamine, of the type of 2-amino-4,6-di-_{C2-C4}-alkylenamino-1,3,5-triazine sequences;
phenol ether sequences based on dihydric phenols and C₂-C₈ diols of the type of-_{C2-C8}-alkylene-O-_{C6-C18}-arylene-O-_{C2-C8}-alkylene-sequences;
are linked by bridge members —NH—CHR₂—NH— or —NH—CHR₂—O—R₄—O—CHR₂—NH— and —NH—CHR₂—NH— and also, where appropriate, —NH—CHR₂—O—CHR₂—NH—, —NH—CHR₂—O—C₅-C₁₈-alkylene-NH— and/or —NH—C₅-C₁₈-alkylene-NH— to form 4- to 1000-nucleus polytriazine ethers with a linear and/or branched structure,
where in the polytriazine ethers the molar ratio of the substituents R₃:R₄=20:1 to 1:20 and the fraction of the linkages of the triazine segments through bridge members —NH—CHR₃—O—R₄—O—CHR₃—NH— is from 5 to 95 mol %.

The terminal triazine segments in the polytriazine ethers are triazine segments of the structure

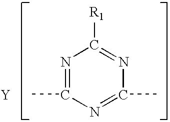

Y═—NH—CHR₂—O—R₃, —NH—CHR₂—O—R₄—OH and, if desired,
—NH—CHR₂—O—C₅-C₁₈-alkylene-NH₂, —NH—C₅-C₁₈-alkylene-NH₂,
—NH—C₅-C₁₈-alkylene-OH,

R₁═—NH₂, —NH—CHR₂—O—R₃, —NH—CHR₂—O—R₄—OH, —CH₃, —C₃H₇, —C₆H₅,
—OH, phthalimido-, succinimido, —NH—CO—R₃, —NH—C₅-C₁₈-alkylene-OH,
—NH—C₅-C₁₈-alkylene-NH₂, —NH—CHR₂—O—C₅-C₁₈-alkylene-NH₂,

R₂═H, C₁-C₇-alkyl;

R₃═C₁-C₁₈-alkyl, H;

R₄═C₂-C₁₈-alkylene,
—CH(CH₃)—CH₂—O_{-C2-C12}-alkylene-O—CH₂—CH(CH₃)—,
—CH(CH₃)—CH₂—O-_{C2-C12}-arylene-O—CH₂—CH(CH₃)—,
—[CH₂—CH₂—O—CH₂—CH₂]ₙ—, —[CH₂—CH(CH₃)—O—CH₂—CH(CH₃)]ₙ—,
—[—O—CH₂—CH₂—CH₂—CH₂—]ₙ—,
—[(CH₂)₂₋₈—O—CO-_{C6-C14}-arylene-CO—O—(CH₂)₂₋₈—]ₙ—,
—[(CH₂)₂₋₈—O—CO-_{C2-C12}-alkylene-CO—O—(CH₂)₂₋₈—]ₙ—,
   where n=1 to 200;
polyester sequences containing siloxane groups, of the type
   —[(X)ᵣ—O—CO—(Y)₉—CO—O—(X)ᵣ]—
in which
X═{(CH₂)₂₋₈—O—CO_{-C6-C14-}arylene-CO—O—(CH₂)₂₋₈—) or
   —{(CH₂)₂₋₈—O—CO_{-C2-C12-}alkylene-CO—O—(CH₂)₂₋₈—} 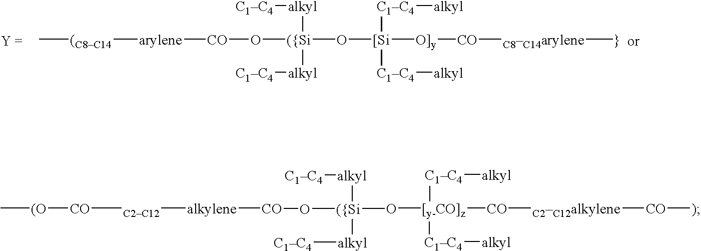
r=1 to 70; s=1 to 70 and y=3 to 50;
polyether sequences containing siloxane groups, of the type 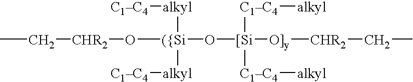
where R₂═H; C₁-C₄-alkyl and y=3 to 50;
sequences based on alkylene oxide adducts of melamine, of the type of 2-amino-4,6-di-_{C2-C4}-alkylenamino-1,3,5-triazine sequences form;
phenol ether sequences based on dihydric phenols and C₂-C₈ diols of the type of-_{C2-C8-}alkylene-O-_{C6-C18}-arylene-O-_{C2-C8}-alkylene-sequences.

The 4- to 1000 nucleus polytriazine ethers used in the process of the invention can be prepared by etherifying melamine resin precondensates with C₁-C₄ alcohols, where appropriate with subsequent partial transetherifcation with C₄-C₁₈ alcohols, C₂-C₁₈ diols, polyhydric alcohols of the glycerol or pentaerythritol type, C₅-C₁₈ amino alcohols, polyalkylene glycols, polyesters containing hydroxyl end groups, siloxane polyesters, siloxane polyethers, melamine-alkylene oxide adducts and/or binuclear-phenol-alkylene oxide adducts and/or reaction with C₅-C₁₈ diamines and/or bisepoxides, and subsequent thermal condensation of the modified melamine resin condensates in the melt in a continuous compounder at temperatures of 140 to 220° C.

Examples of maleic anhydride copolymers used where appropriate in the process of the invention are C₂-C₂₀ olefin-maleic anhydride copolymers or copolymers of maleic anhydride and C₈-C₂₀ vinylaromatics.

Examples of the C₂-C₂₀ olefin components which may be present in the maleic anhydride copolymers are ethylene, propylene, but-1-ene, isobutene, diisobutene, hex-1-ene, oct-1-ene, hept-1-ene, pent-1-ene, 3-methylbut-1-ene, 4-methylpent-1-ene, methylethylpent-1-ene, ethylpent-1-ene, ethylhex-1-ene, octadec-1-ene and 5,6-dimethylnorbornene.

Examples of the C₈-C₂₀ vinylaromatic components which may be present in the maleic anhydride copolymers are styrene, α-methylstyrene, dimethylstyrene, isopropenylstyrene, p-methylstyrene and vinylbiphenyl.

Examples of the modified maleic anhydride copolymers used where appropriate in the process of the invention are partially or fully esterified, amidated and/or imidated maleic anhydride copolymers.

Particular suitability is possessed by modified copolymers of maleic anhydride and C₂-C₂₀ olefins and/or C₈-C₂₀ vinylaromatics with a molar ratio of 1:1 to 1:9 and molar mass weight averages of 5000 to 500 000 that have been reacted with ammonia, C₁-C₁₈-monoalkylamines, C₆-C₁₈ aromatic monoamines, C₂-C₁₈ monoamino alcohols, monoaminated poly(C₂-C₄-alkylene) oxides with a molar mass of 400 to 3000, and/or monoetherified poly(C₂-C₄-alkylene) oxides with a molar mass of 100 to 10 000, the molar ration of anhydride groups of copolymer to ammonia, amino groups of C₁-C₁₈-monoalkylamines, C₆-C₁₈ aromatic monoamines, C₂-C₁₈ monoamino alcohols and/or monoaminated poly(C₂-C₄-alkylene) oxide and/or hydroxyl groups of poly(C₂-C₄-alkylene) oxide being 1:1 to 20:1.

Examples of the nanoparticles used where appropriate in the process of the invention, in the form of phyllosilicates, are montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, boron fluorophlogopites and synthetic smectites.

In the process of the invention the meltable amino resin polycondensates containing, where appropriate, maleic anhydride copolymers and/or nanoparticles are used preferably in the form of cylindrical, lenticular, lozenge-shaped or spherical particles having an average diameter of 0.5 to 8 mm in the preparation of the amino resin melts.

Suitable for preparing the melts of the amino resin polycondensates prior to the application of the actinic radiation are continuous compounders, preferably extruders having short compression screws or three-section screws with L/D=20-40. Preference is given to 5-section screws with an intake section, compression section, shearing section, decompression section and homogenizing section. Screws with depths of cut of 1:2.5 to 1:3.5 are preferentially suitable.

Particularly favourable is the interposition of static mixers or melt pumps between barrel and die.

Maleic anhydride copolymers and/or nanoparticles, where these components have not been incorporated during the actual readying of the amino resin polycondensates, can likewise be added in the continuous compounder to the melt of the amino resin polycondensates.

The temperatures of processing from the melt of the amino resin polycondensates containing light-activable curing agents are determined by the temperature interval above the melting point of the amino resin polycondensates and below the thermoinduced decomposition temperature of the light-activable curing agents.

For an amino resin polycondensate it is advantageous to use a light-activable curing agent whose thermoinduced decomposition temperature is at least 450 degrees above the melting temperature of the amino resin polycondensate. Customary residence times in the continuous compounder when preparing and homogenizing the melt are 2 to 12 min.

In the process of the invention for curing amino resins, layers of amino resins are preferably cured continuously by irradiating the melt layer of the amino resin polycondensate applied to moving carrier materials.

The application of the amino resin melt to the moving carrier material can take place by means of a slot die or by spraying.

Examples of carrier materials to which the melt layer of the amino resin polycondensate is applied in the course of the process of the invention for the purpose of subsequent curing by irradiation are webs of sheetlike textile structures such as nonwovens and wovens, paper, paperboard or wood veneer, or sheet material of wood, including plywood, wood chipboard, wood fibreboard of multilayer composite board.

Thin foamed layers on the carrier materials can be produced if the melts of the amino resin polycondensates contain gas-evolving blowing agents such as sodium hydrogencarbonate, azodicarboxamide, citric acid/bicarbonate blowing systems and/or cyanuric trihydrazide, or if volatile hydrocarbons such as pentane, isopentane, propane and/or isobutane, or gases such as nitrogen, argon and/or carbon dioxide, are introduced into the melt before it is discharged, with foaming of the layer taking place as the melt is discharged from the slot die.

In the process of the invention for curing amino resins the curing of filaments or fibrids of amino resins takes place preferably continuously by irradiation of the filaments or fibrids, discharged in the form of a viscous melt, after the fibre-forming operation.

The production of filament yarns by the process of the invention can take place in short spinning units by transferring the amino resin polycondensate melt, containing light-activable curing agents, into the capillary die using a melt pump, extruding the filaments into the blowing shaft while at the same time applying actinic light, and taking off the filaments using high-speed godets and subjecting them to further processing in downstream installations comprising thermal aftercure chamber, drawing apparatus and winders.

Fibrids and nonwovens in accordance with the process of the invention can be produced by the melt-blown process by transferring the amino resin polycondensate melt, containing light-activable curing agents, into the capillary die using a melt pump, extruding the filaments from the capillary die into the blowing shaft, while applying a hot stream of air around the apertures in the capillary die and at the same time carrying out irradiation with actinic light. The stream of air stretches the melted filament and at the same time divides it into a large number of small individual fibres with diameters of 0.5 to 12 μm. The fibrids deposited on the screen conveyor belt can be processed further to nonwovens by applying thermobonding or needling operations in order to achieve the required strength and dimensional stability.

Further in accordance with the invention are amino resin products, preferably sheetlike textile structures or coatings, produced by the process described above.

Examples of sheetlike textile structures are fire-resistant and heat-protection clothing containing amino resin fibres, fire-resistant ceilings, temperature-stable electrical insulation fabric, filter inserts for hot gases, and felts for paper making machines.

Examples of coatings are amino-resin-coated sheetlike textile structures such as nonwovens and wovens and also amino-resin-coated paper, paperboard or wood veneer, or coated sheet material of wood, including plywood, wood chipboard, wood fibreboard or multilayer composite board.

The invention is illustrated by the following examples:

The exposure unit used for irradiation with actinic light was a Fusion UV system model F600s with I 600-44 lamp section, lamp output 240 W/cm, 6000 W in total, with microwave-pulsed H lamp (Hg spectrum, principal emissions at 200-320 nm and 365 nm), elliptical reflector geometry and cooling by means of an external fan.

To determine the force required for permanent deformation in the scratching test the surface of the cured resin layer was traversed by a needle whose load is increased from 0 to 40 mN in 10 loading steps. The parameter determined is the force at which the surface of the cured resin layer is permanently deformed.

### EXAMPLE 1

The melamine resin used is a polycondensate of melamine and formaldehyde with a melamine/formaldehyde ratio of 1:3. The methylol groups of the melamine resin are predominantly etherified by methanol; the methoxy group content of the resin is 20% by mass. The molar mass of the resin is around 2000 g/mol.

The etherified melamine resin is homogenized in the melt at 140° C. with 1% by mass, based on the melamine resin, of 2-(4-methoxyphenyl)-4,6-bis(trichloromethyl)-1,3,5-triazine as light-activable curing agent and the liquid melt mixture is applied to the surface of a pinewood sheet (thickness 10 mm) in a layer thickness of 50 μm, using a doctor blade, the sheet having been heated to 140° C. beforehand, and the coated sheet is irradiated in the exposure unit. For that purpose the sheet is passed beneath the lamp on a conveyor belt and exposed with an output of 1.4 W/cm² with an oxygen concentration of 15% by volume and a temperature of 140° C.

The result is a tack-free, fully cured surface. In the scratch test the surface of the cured resin layer is permanently deformed only when a force of 28 mN is applied. In a comparative experiment on an unirradiated coated sheet under the same experimental conditions the surface of the resin layer undergoes permanent deformation at a force of only 4 mM.

### EXAMPLE 2

Experimental procedure as in Example 1. The light-activable curing agent used is 2% by mass, based on the melamine resin, of 2-(4-methoxyphenyl)-4,6-bis(tri-chloromethyl)-1,3,5-triazine. Exposure with an output of 1.0 W/cm² at an oxygen concentration of 15% by volume and a temperature of 140° C. leads to tack-free, fully cured surface. In the scratch test the surface of the resin layer is permanently deformed starting from a load of 32 mM.

### EXAMPLE 3

Experimental procedure as in Example 1. At a reduced oxygen concentration of 100 ppm and with the same light output the results obtained are like those in Example 1.

### EXAMPLE 4

Experimental procedure as in Example 1. The light-activable curing agent used is a blocked sulphonic acid of the formula

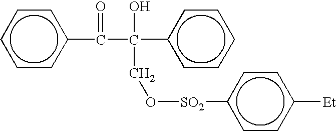

in a concentration of 1% by mass, based on the melamine resin.

The melt of the resin/curing agent mixture is applied with a layer thickness of 50 μm to a glass plate (thickness 6 mm) which has been heated to 140° C. beforehand. Under irradiation conditions as in Example 1 a fully cured surface is obtained with an output of just 0.5 W/cm². In the scratch test the surface of the resin layer is observed to undergo permanent deformation starting from a force of 30 mN.

### EXAMPLE 5

Experimental procedure as in Example 1; the light-activable curing agent used is a diazonium salt of the formula

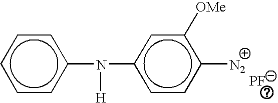

in a concentration of 1% by mass, based on the melamine resin. A fully cured surface is obtained.

### EXAMPLE 6

Experimental procedure as in Example 1; the light-activable curing agent used is a blocked sulphonic acid of the formula

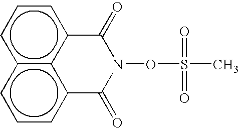

in a concentration of 1% by mass, based on the melamine resin.

The melt of the resin/curing agent mixture is applied with a layer thickness of 50 μm to a glass plate (thickness 6 mm) which has been heated to 140° C. beforehand. Under irradiation conditions as in Example 1 a fully cured surface is obtained.

### EXAMPLE 7

The melamine resin used is a melamine-formaldehyde precondensate based on 2,4,6-trismethoxymethylamino-1,3,5-triazine and transetherified with an ethylene glycol diether of bisphenol A (Simulsol BPLE, Seppic S. A., France). The molar mass determined by GPC is 1800, the amount of unreacted Simulsol BPLE by HPLC analysis (solution in THF, UV detection with external standard) is 14% by mass. The fraction of the —OCH₃ groups in the transetherified melamine resin (determined by GC analysis following cleavage of the polytriazine ether with mineral acid) is 14.5% by mass. The viscosity at 140° C. is 800 Pa.s.

The transetherification of the melamine-formaldehyde precondensate based on 2,4,6-trismethoxymethylamino-1,3,5-triazine and further condensation take place at 200° C. in a GL 26 D44 laboratory extruder with vacuum devolatilizer (Leistritz) with a temperature profile of 100° C./130° C./130° C./200° C./200° C./200° C./200° C./200° C./200° C./100° C./100° C. and an average residence time of 2 to 3 min. The extruder speed is 150 min⁻¹. The intake zone of the extruder is fed gravimetrically through a side-stream feed with 2,4,6-trismethoxmethylamino-1,3,5-triazine at 1.38 kg/h and with the ethylene glycol diether of bisphenol A at 1.13 kg/h. The strand of the polytriazine ether emerging from the extruder is chopped in a pelletizer.

The transetherified melamine resin is compounded at 130° C. with 1% by mass, based on the melamine resin, of 2-(4-methoxyphenyl)-4,6-bis(trichloromethyl)-1,3,5-triazine as light-activable curing agent. The compound is melted in an extruder at a melt temperature of 150° C. and is spun to filaments via a spinning pump and spinnerets at 145° C. The high-viscosity liquid melt filaments are irradiated at 135° C. in the exposure unit with an output of 1 W/cm². The fibres obtained in this way, which are 35 μm thick, can be wound up without sticking, whereas unexposed fibres very soon stick to one another.

1. A process for curing amino resins comprising curing layers having a thickness of up to 300 μm or filaments or fibrids with a diameter of up to 300 μm comprising
a.) from 95 to 99.95% by mass of solvent-free meltable amino resin polycondensates having molar masses of 1000 to 300 000,
b from 5 to 0.05% by mass of curing agents which can be activated by actinic light and are composed of
b1) acid formers of the type of blocked sulphonic acid of the general formula (I)
R₁—SO₂—O—R₂ (I)
R₁=unsubstituted or substituted aryl, biphenyl or alkyl,
R₂=4-nitrobenzyl, pentafluorobenzyl, 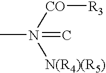
substituents or 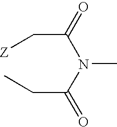
substituents,
Z═_{C6-C24}-aryl, _{C6-C4}-alkyl, _{C6-C4}-alkenyl, _{C7-C8}-bicycloalkenyl,
where
R₃=non-substituted or substituted alkyl or aryl,
R₄═H, C₁-C₁₂-alkyl, phenyl, C₂-C₉-alkanoyl or benzyl,
R₅═H, C₁-C₁₂-alkyl or cyclohexyl
or R₃ and R₄ or R₅ together with the atoms to which they are attached form a 5- to 8-membered ring which can be fused by 1 or 2 benzo radicals,
and/or
b2) halogen-substituted triazine derivatives of the general formula (II) 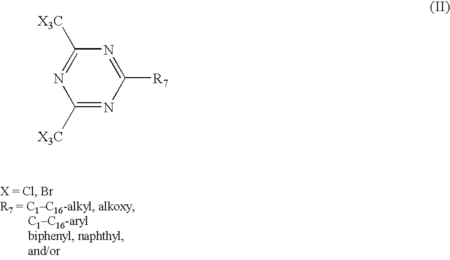
b3) onium salts of the type of aryldiazonium salts, diarylhalonium salts, triarylsulphonium salts, triarylselenonium salts and/or N-alkoxypyridinium salts, and if desired
g) from 1 to 20% by mass, based on the meltable amino resin polycondensates, of non-modified and/or modified maleic anhydride copolymers, and/or
h) from 0.1 to 5% by mass, based on the meltable amino resin polycondensates, of nanoparticles in the form of phyllosilicates, hydrophilic or hydrophobic synthetic silicas, calcium carbonate or metal oxides of the ZnO, SnO, Al₂O₃ or TiO₂ type.
by irradiation with actinic light at a temperature between the melting point of the amino resin polycondensate and the thermoinduced decomposition temperature of the light-activable curing agents, and optionally subjecting the layers, filaments or fibrids to a thermal aftercure below 250° C.

2. The process for curing amino resins according to claim 1, wherein the acid formers of the type of blocked sulphonic acid of the general formula
R₁—SO₂—O—R₂ (I)
are blocked sulphonic acids in which the substituents
R₁=unsubstituted or singly or multiply halogen-, C₁-C₄-haloalkyl-, C₁-C₁₆-alkyl-,
C₁-C₄-alkoxy-, C₁-C₄-alkyl-CO—NH—, phenyl-CO—NH—, benzoyl- and/or nitro-substituted C₆-C₁₀-aryl or C₇-C₁₂-arylalkyl,
R₂=4-nitrobenzyl, pentafluorobenzyl, 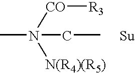
substituents, or 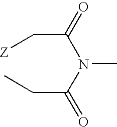
substituents,
Z═_{C6-C24}-aryl, _{C2-C4}-alkyl, _{C2-C}₄-alkenyl, _{C7-C8}-bicycloalkenyl,
where
R₃═C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl-, C₁-C₄-alkoxy-, C₁-C₄-alkyl-CO—NH—, phenyl-CO—NH—, benzoyl- and/or nitro-substituted C₆-C₁₀-aryl and/or C₇-C₁₂-arylalkyl, C₁-C₈-alkoxy, C₅-C₈-cycloalkoxy, phenoxy or H₂N—CO—NH—, —CN, C₂-C₅-alkyloyl, benzoyl, C₂-C₅-alkoxycarbonyl, phenoxycarbonyl, morpholino, piperidino, C₁-C₁₂-alkyl, C₁-C₄-haloalkyl, C₂-C₆-alkenyl, C₅-C₁₂-cycloalkyl, unsubstituted or singly or multiply halogen-, C₁-C₄-haloalkyl-, C₁-C₁₆-alkyl, C₁-C₄-alkoxy, C₁-C₄-alkyl-CO—NH—, phenyl-CO—NH—, benzoyl- and/or nitro-substituted C₆-C₁₀-aryl, C₇-C₁₂-arylalkyl, C₁-C₈-alkoxy, C₅-C₈-cycloalkoxy-, phenoxy- or H₂N—CO—NH—,
R₄═H, C₁-C₁₂-alkyl, phenyl, C₂-C₉-alkanoyl or benzyl
R₅═H, C₁-C₁₂-alkyl or cyclohexyl,
or R₃ and R₄ or R₅ together with the atoms to which they are attached form a 5- to 8-membered ring which can be fused by 1 or 2 benzo radicals.

3. The process for curing amino resins according to claim 2, wherein the acid former of the type of blocked sulphonic acid of the general formula
R₁—SO₂—O—R₂ (I)
is a blocked sulphonic acid of the structure

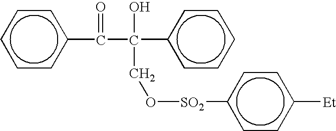

4. The process for curing amino resins according to claim 1, wherein the acid formers of the type of halogen-substituted triazine derivatives of the general formula (II) 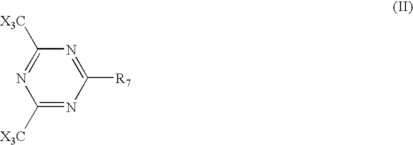
are halogen-substituted triazine derivatives in which
X═Cl and R₇=p-methoxyphenyl.

5. The process for curing amino resins according to claim 1, wherein the onium salt is an onium salt of the formula

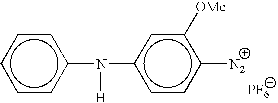

6. The process for curing amino resins according to claim 1, wherein the amino resin polycondensates are polycondensates of melamine resins, urea resins, cyanamide resins, dicyandiamide resins, sulphonamide resins and/or guanamine resins.

7. The process for curing amino resins according to claim 1, wherein the polycondensates of melamine resins are mixtures of meltable 4- to 1000-nucleus polytriazine ethers,
wherein the polytriazine ethers the triazine segments 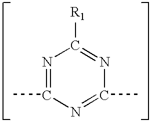
R₁═—NH₂, —NH—CHR₂—O—R₃, —NH—CHR₂—O—R₄—OH, —CH₃, —C₃H₇, —C₆H₅, —OH, phthalimido-, succinimido-, —NH—CO-_{C5-C18}-alkyl, —NH—C₅-C₁₆-alkylene-OH,
—NH—CHR₂—O—C₅-C₁₈-alkylene-NH₂, —NH—C₅-C₁₈-alkylene-NH₂,
—NH—CHR₂—O—R₄—O—CHR₂—NH—, —NH—CHR₂—NH—,
—NH—CHR₂—O—C₅-C₁₈-alkylene-NH—, —NH—C₅-C₁₈-alkylene-NH—, —NH—CHR₂—O—CHR₂—NH—,
R₂═H, C₁—H₇-alkyl:
R₃═C₁-C₁₈-alkyl, H;
R₄═C₂-C₁₈-alkylene,
—CH(CH₃)—CH₂—O_{-C2-C12}-alkylene-O—CH₂—CH(CH₃)—, —CH(CH₃)—CH₂—O-_{C2-C12}-arylene-O—CH₂—CH(CH₃)—,
—[CH₂—CH₂—O—CH₂—CH₂]ₙ—, —[CH₂—CH(CH₃)—O—CH₂—CH(CH₃)]_{n—,}
—[—O—CH₂—CH₂—CH₂—CH₂—]ₙ—,
—[(CH₂)₂₋₈—O—CO-_{C6-C14}-arylene-CO—O—(CH₂)₂₋₈—]ₙ—,
—[(CH₂)₂₋₈—O—CO-_{C2-C12}-alkylene-CO—O—(CH₂)₂₋₈—]ₙ—,
where n=1 to 200;
polyester sequences containing siloxane groups, of the type
—[(X)ᵣ—O—CO—(Y)₉—CO—O—(X)ᵣ]—
in which
X═{(CH₂)₂₋₈—O—CO_{-C8-C14-}arylene-CO—O—(CH₂)₂₋₈—} or
—{(CH₂)₂₋₈—O—CO_{-C2-C12-}alkylene-CO—O—(CH₂)₂₋₈—} 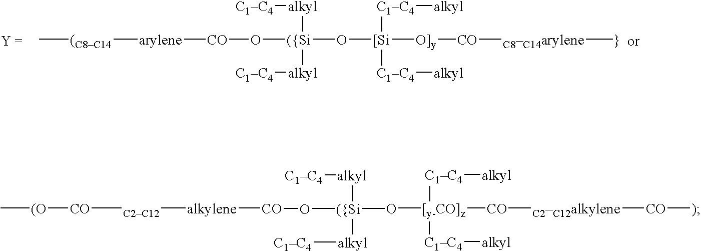
r=to 70; s=1 to 70 and y=3 to 50;
polyether sequences containing siloxane groups, of the type 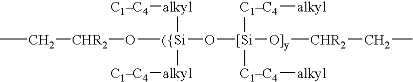
where R₂═H; C₁-C₄-alkyl and y=3 to 50;
sequences based on alkylene oxide adducts of melamine, of the type of 2-amino-4,6-di-_{C2-C4}-alkylenamino-1,3,5-triazine sequences;
phenol ether sequences based on dihydric phenols and C₂-C₈ diols of the type of -_{C2-C8}-alkylene-O_{-C6-C18}-arylene-O-_{C2-C8}-alkylene- sequences;
are linked by bridge members —NH—CHR₂—NH— or
—NH—CHR₂—O—R₄—O—CHR₂—NH— and —NH—CHR₂—NH— and also, where appropriate, —NH—CHR₂—O—CHR₂—NH—,
—NH—CHR₂—O—C₅-C₁₈-alkylene-NH— and/or —NH—C₅-C₁₈-alkylene-NH— to form 4- to 1000-nucleus polytriazine ethers with a linear and/or branched structure,
where in the polytriazine ethers the molar ratio of the substituents R₃:R₄=20:1 to 1:20 and the fraction of the linkages of the triazine segments through bridge members —NH—CHR₃—O—R₄—O—CHR₃—NH— is from 5 to 95 mol %.

8. The process for curing amino resins according to claim 1, wherein the curing of layers of amino resins takes place continuously by irradiation of the melt layer of the amino resin polycondensate applied to moving carrier materials.

9. The process for curing amino resins according to claim 1, wherein the curing of filaments or fibrids of amino resins takes place continuously by irradiation of the filaments or fibrids, discharged as a viscous melt, following the fibre-forming operation.

10. Amino resin products, produced according to claim 1.

11. The amino resin products according to claim 10 as sheet textile structures or coatings.

12. The amino resin products according to claim 2 as sheet textile structures or coatings.

13. The amino resin products according to claim 3 as sheet textile structures or coatings.

14. The amino resin products according to claim 4 as sheet textile structures or coatings.

15. The amino resin products according to claim 5 as sheet textile structures or coatings.

16. The amino resin products according to claim 6 as sheet textile structures or coatings.

17. The amino resin products according to claim 7 as sheet textile structures or coatings.

18. The amino resin products according to claim 8 as sheet textile structures or coatings.

19. The amino resin products according to claim 9 as sheet textile structures or coatings.
